(19) United States
(12) Patent Application Publication
(10) Pub. No.: US 2026/0153719 A1
(43) Pub. Date: Jun. 4, 2026

(54) DYNAMIC REMOTE REFOCUS MICROSCOPE

(71) Applicant: CALICO LIFE SCIENCES LLC, South San Francisco, CA (US)

(72) Inventor: Alfred Millett-Sikking, Pacifica, CA (US)

(21) Appl. No.: 19/122,580

(22) PCT Filed: Oct. 20, 2023
(86) PCT No.: PCT/US2023/035588

§ 371 Date: Apr. 18, 2025

Related U.S. Application Data
(60) Provisional application No. 63/418,256, filed on Oct. 21, 2022.

(51) Int. Cl. G02B 21/02; G02B 21/18; G02B 21/33

(52) U.S. Cl. CPC G02B 21/025; G02B 21/18; G02B 21/33

(57) ABSTRACT

Remote refocus microscope systems are disclosed. The system includes a first microscope arranged to receive light from the sample in a medium having a sample refractive index ns with a first objective lens having a first numerical aperture NAi and a first immersion medium with a first refractive index m, a second microscope including a second objective lens having a second numerical aperture NA2 and a second refractive index U2, and an optical compensator disposed between the first microscope and the second microscope, the optical compensator comprising at least one lens having a linearly adjustable position to provide for MRR to be continuously tuned to approximately equal to a ratio of (ns/n2). The system is modular where the first objective can be changed to permit operation in one of three modes. Methods for configuring a remote refocus microscope into one of three modes are also disclosed.

### CROSS-REFERENCE TO RELATED APPLICATIONS

This application claims priority to U.S. Patent Application No. 63/418,256, filed Oct. 21, 2022, the entire contents of which is incorporated herein by reference in its entirety.

### SUMMARY OF INVENTION

In accordance with an aspect, there is provided a remote refocus system configured to image a sample. The system may include a first microscope arranged to receive light from the sample in a medium having a sample refractive index (RI) nₛ. The first microscope may include a first objective lens having a first numerical aperture NA₁ and a first immersion medium with a first refractive index n₁. The system may include a second microscope including a second objective lens having a second numerical aperture NA₂ and a second refractive index n₂. The second objective lens may be disposed and arranged to receive light passing through the first microscope. The combination of the first microscope and second microscope may be configured to produce an intermediate image of the sample with a magnification M_{RR}. The system further may include an optical compensator disposed between the first microscope and the second microscope. The optical compensator may include at least one lens having a linearly adjustable position to provide for M_{RR} to be continuously tuned to approximately equal to a ratio of (nₛ/n₂).

In some embodiments, the sample refractive index nₛ may be greater than the first refractive index n₁. In some embodiments, the sample refractive index nₛ may be less than the first refractive index n₁. In some embodiments, the sample refractive index nₛ may be substantially the same as the first refractive index n₁.

In some embodiments, M_{RR} may be approximately equal to a ratio of (nₛ/n₂) of the refractive indices of the sample and second microscope, i.e., second objective.

In some embodiments, nₛ may be in a range of 1.00 to 2.00, e.g., from 1.00 to about 1.40, about 1.25 to about 1.60, about 1.50 to about 1.80, or about 1.75 to about 2.00. In particular embodiments, nₛ is in a range of 1.33 to 1.51.

In some embodiments, n₁ may be in a range of 1.00 to 2.00, e.g., from 1.00 to about 1.40, about 1.25 to about 1.60, about 1.50 to about 1.80, or about 1.75 to about 2.00. In particular embodiments, n₁ is in a range of 1.00 to 1.51.

In some embodiments, the first objective may be constructed and arranged to be switched between different objectives having the same focal length but different refractive indices n₁ such that the system maintains M_{RR} approximately equal to a ratio of (nₛ/n₂).

In some embodiments, the first objective may be constructed and arranged to be switched between different objectives having different focal lengths and different refractive indices n₁ such that the optical compensator maintains M_{RR} approximately equal to a ratio of (nₛ/n₂).

In some embodiments, a collection half angle of the second objective is greater than or approximately equal to a collection half angle of the first objective.

In accordance with an aspect, there is provided a modular microscopy system for imaging a sample. The system may include a sample stage constructed and arranged for holding sample immersed in a sample medium having sample refractive index nₛ. The system may include a first microscope having a first objective lens having a first numerical aperture NA₁ and a first immersion medium with a first refractive index n₁. The system further may include a second microscope having a second objective lens having a second numerical aperture NA₂ and a second refractive index n₂, the combination of the first microscope and second microscope configured to produce an intermediate image of the sample with a magnification M_{RR}. The system additionally may include an optical compensator disposed between the first microscope and the second microscope and including at least one lens having a linearly adjustable position to provide for M_{RR} to be continuously tuned to approximately equal to a ratio of (nₛ/n₂). The modular microscopy system may have the sample refractive index nₛ and the first refractive index n₁ chosen to permit operation in three modes:
a first mode where the sample refractive index nₛ is equal to the first refractive index n₁;
a second mode where the sample refractive index nₛ is greater than the first refractive index n₁; and
a third mode where the sample refractive index nₛ is less than the first refractive index n₁.

In some embodiments, nₛ may be in a range of 1.00 to 2.00, e.g., from 1.00 to about 1.40, about 1.25 to about 1.60, about 1.50 to about 1.80, or about 1.75 to about 2.00. In particular embodiments, nₛ is in a range of 1.33 to 1.51.

In some embodiments, n₁ may be in a range of 1.00 to 2.00, e.g., from 1.00 to about 1.40, about 1.25 to about 1.60, about 1.50 to about 1.80, or about 1.75 to about 2.00. In particular embodiments, n₁ is in a range of 1.00 to 1.51.

In accordance with an aspect, there is provided a method of configuring a remote refocus system including a first microscope and a second microscope for imaging a sample. The method may include selecting a first objective for the first microscope based on a chosen compromise between first, second, and third modes of operation for the remote refocus system and a refractive index of the sample. The first, second, and third modes of operation may include: 1) the first mode of operation being the use of an immersion-free objective for the first microscope where the sample refractive index nₛ is greater than a first refractive index n₁ of the first objective; 2) the second mode of operation including an expanded focus range of the first objective where the sample refractive index nₛ is substantially identical to the first refractive index n₁ of the first objective; and 3) the third mode of operation for maximizing the numerical aperture (NA) of the first objective where the sample refractive index nₛ is less than the first refractive index n₁ of the first objective. The method may include selecting a second objective having second refractive index n₂ for the second microscope, with the first microscope and second microscope being configured to produce an intermediate image of the sample with a magnification M_{RR}. The method further may include selecting a combination of optics for an optical compensator disposed between the first objective and second objective to collect substantially all the emission light from the first objective. The optical compensator may have a linearly adjustable position to provide for M_{RR} to be continuously tuned to approximately equal to a ratio of (nₛ/n₂).

In some embodiments, selecting the first objective may include selecting an air objective. In some embodiments, selecting the first objective may include selecting a water immersion objective. In some embodiments, selecting the first objective may include selecting an oil immersion objective. For example, an oil immersion objective may include a silicone oil immersion objective or a glycerol immersion objective.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIGS. 1A-1C illustrate a remote refocus microscopy system including an optical compensator, according to different embodiments. FIG. 1A illustrates a system for imaging a sample where the sample refractive index nₛ is substantially the same as the first refractive index n₁. FIG. 1B illustrates a system for imaging a sample where the sample refractive index nₛ is greater than the first refractive index n₁. FIG. 1C illustrates a system for imaging a sample where the sample refractive index nₛ is less than the first refractive index n₁.

FIGS. 2A-2B illustrate the focusing range of a standard single objective widefield microscope using air, water, and oil objectives. FIG. 2A illustrates the focusing range for objectives with the highest numerical aperture (NA). FIG. 2B illustrates the focusing range for objectives with the most pixels.

FIGS. 3A-3B illustrate the focusing range of a remote refocus microscope using air, water, and oil objectives as a first objective and remote optics optimized for samples having a refractive index between 1.33-1.51. FIG. 3A illustrates the focusing range for objectives with the highest numerical aperture (NA). FIG. 3B illustrates the focusing range for objectives with the most pixels.

FIGS. 4A-4B illustrate a zoom lens system in accordance with one or more non-limiting embodiments.

### DETAILED DESCRIPTION

Aspects and embodiments are directed to methods and apparatus for improved microscope imaging of samples with mismatched RI.

Choosing an objective lens is an important consideration when using a visible light microscope. For example, an objective's numerical aperture (NA) and field of view (FOV) will determine the maximum available resolution and object size in the image. When a 3D semi-transparent sample is imaged at high NA, the focal plane should be adjusted to access available volumetric information. For example, the objective of the microscope can be moved towards the object to acquire a series of 2D images at different depths; this is known as the “standard focus” method. In the standard focus method, the maximum imaging depth of a typical widefield microscope is therefore limited by the working distance (WD) of the objective, i.e., the amount of travel of the objective.

The positive working distance for standard focusing includes the “final elements'” in the objective lens design where the shape and the refractive index are considerations. The shape is fixed by the image plane and the final solid surface of the objective, generally a glass lens. However, the RI of this space can vary, i.e., the immersion medium and/or a coverslip alters the RI of the space. In a standard focus experiment to image deeper into a sample, “slabs'” of intended immersion media, e.g., air, water, or oil, are effectively exchanged for slabs of sample. If the sample RI matches the objective RI, then this is a null operation and the objective will image as designed. However, if there is a refractive index mismatch, then the slab of sample, e.g., with an unintended RI, will produce spherical aberration at finite NA, making the images blurry with enough depth.

Thus, it follows that for aberration-free standard focusing, the first objective's refractive index n₁ should be set equal to the sample refractive index:

$${n}_{1} = {n}_{s}$$

Having to match the refractive index of the objective and sample for 3D imaging poses challenges. The RI of biological samples varies significantly, creating a large number of objective options. Air immersion objectives are the most convenient and are excellent for high-speed tiling but have the lowest NA and low depth penetration due to the large RI difference. Water immersion objectives are generally a good RI match for live samples, e.g., an aqueous suspension of cells, but require regular hydration to reduce evaporation and water has the lowest NA of the liquid immersions. Oil immersion objectives provide the highest NA and are insensitive to coverslip thickness but generally have lower depth performance due to the RI mismatch. A compromise between NA and RI matching are silicone oil immersion objectives, but challenges remain for specific applications. Thus, there is a need for improved microscopy that eliminates the challenges of sample choice and RI mismatch.

Remote refocus (RR) optics are used in high-speed 3D imaging, such as in single-objective light-sheet (SOLS) microscopes. One feature of an RR optical setup is the ability to adjust the focal plane without moving either the primary objective or the sample, for example by moving one of the downstream objectives, in contrast to a standard focus experiment. In a remote refocus experiment, slabs of different refractive indices between the sample and a downstream remote space can be exchanged. As a non-limiting example, an air immersion optical setup can used in the downstream remote space with an aqueous sample. In this configuration, spherical aberration can be avoided by setting the magnification between the sample and downstream remote space to preserve angles:

$${M}_{RR} = \frac{{n}_{s}}{{n}_{2}}$$

where M_{RR} is the remote refocus (RR) magnification and n₂ is the RI of the immersion of the downstream remote space, which is equal to that of the second objective n₂. Here, improved imaging can be achieved by optimizing the remote refocus for the refractive index of the sample and not the immersion of the first objective.

In a general RR system, the sample and first objective RI would be equal, i.e., n₁=nₛ, thus permitting the maximum range for both standard focus and remote refocus experiments. If the RI of the sample and first objective differ, then the range of standard focusing will be reduced, but the remote refocus range can persist. Alternatively, if the sample and first objective RI are matched, but the remote refocus optics are optimized for a different RI, then the RR range will be reduced and the standard focus range will persist. As disclosed herein, it is thus counterintuitive to deviate from the typical system design, where the first objective and remote refocus are optimized for the same sample RI. The systems and methods disclosed herein, e.g., having mismatched RI, can provide for improved microscopy imaging by allowing for the selection of objectives to increase the range of time-lapse imaging, high-speed tiling, or increased NA for the imaging of live biological samples.

In accordance with an aspect, there is provided a remote refocus system configured to image a sample. The system includes a first microscope arranged to receive light from the sample in a medium having a sample refractive index nₛ. The first microscope includes a first objective lens having a first numerical aperture NA₁ and a first immersion medium with a first refractive index n₁. The system includes a second microscope having a second objective lens with a second numerical aperture NA₂ and a second refractive index n₂. The second objective lens is disposed and arranged to receive light passing through the first microscope. The combination of the first microscope and second microscope is constructed and arranged to produce an intermediate image of the sample with a magnification M_{RR}. The system further includes an optical compensator disposed between the first microscope and the second microscope. The optical compensator may include at least one lens having a linearly adjustable position to provide for M_{RR} to be continuously tuned to approximately equal to a ratio of (nₛ/n₂).

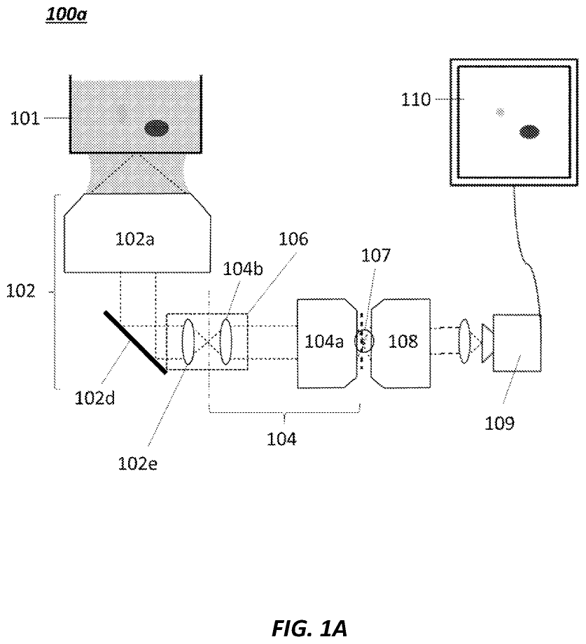

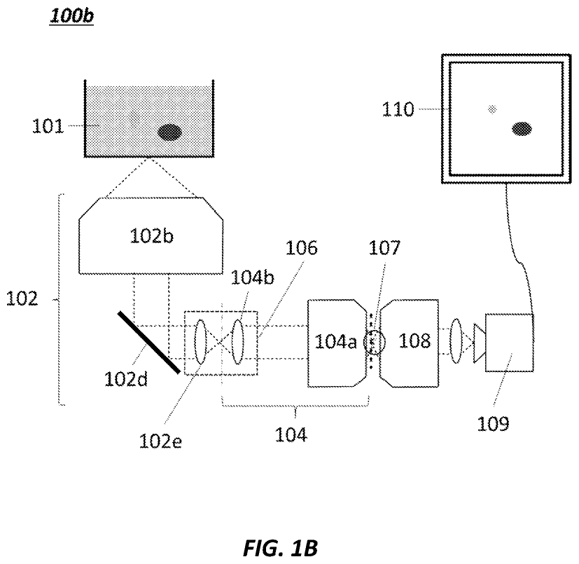

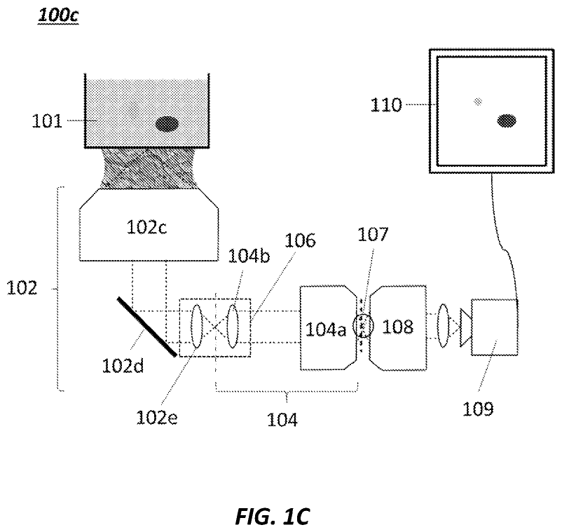

Embodiments of remote refocus system configured to image samples dispersed in a medium of refractive index nₛ are illustrated in FIGS. 1A-1C. With reference to FIGS. 1A-1C, remote refocus system 100a, 100b, and 100c include first microscope 102 positioned to receive light, e.g., substantially all light, from sample 101 dispersed in a sample medium nₛ. The sample 101 is positioned on a suitable sample stage and affixed with a coverslip. In FIGS. 1A-1C, the first microscope 102 includes a first objective lens 102a, 102b, and 102c having a first numerical aperture NA₁ and a first immersion medium with a first refractive index n₁. As illustrated in FIGS. 1A-1C, the three first objective lenses 102a, 102b, and 102c of the first microscope 102 provide for a modular microscopy system providing a selection of the first refractive index n₁ to permit operation in three modes. The first microscope 102 also includes an optional fold mirror 102d to direct light and a first tube lens 102e that is positioned to collect light from optional fold mirror 102d and direct into another optical component of the remote refocus system 100a, 100b, and 100c. The first objective 100a, 100b, and 100c is constructed and arranged to be switched between different objectives having the same focal length but different refractive indices n₁ such that the system maintains M_{RR} approximately equal to a ratio of (nₛ/n₂). Alternatively, or in addition, the first objective 102a, 102b, and 102c is constructed and arranged to be switched between different objectives having different focal lengths and different refractive indices mi such that the optical compensator maintains M_{RR} approximately equal to a ratio of (nₛ/n₂). The choices available for the first objective 102a, 102b, and 102c and focal length permit imaging that maximizes the NA for samples having nₛ below n₁ and increases the imaging depth for immersion-free imaging beyond depths typical for standard focus or widefield microscopy setups.

The remote refocus system 100a, 100b, and 100c further includes a second microscope 104 including a second objective lens 104a having a second numerical aperture NA₂ and a second refractive index n₂. The second objective lens 104a is positioned and arranged to receive light, e.g., substantially all the light, passing through the first microscope 102, e.g., from first objective 102a, 102b, 102c, optional fold mirror 102d, and first tube lens 102c. The collection half angle of the second objective 104a is greater than or approximately equal to a collection half angle of the first objective 102a, 102b, and 102c. The second microscope 104 further includes second tube lens 104b positioned between the first tube lens 102e and the second objective 104a. The image plane of the first microscope 102 is between the first tube lens 102e and second tube lens 104b. When arranged together, the combination of the first microscope 102 and the second microscope 104 are configured to produce an intermediate image of the sample 107 with a magnification M_{RR}.

With continued reference to FIGS. 1A-1C, the system 100a, 100b, and 100c includes an optical compensator 106 disposed between the first microscope 102 and the second microscope 104. As illustrated, the optical compensator 106 includes at least one of the first tube lens 102e and second tube lens 104b, where one or both of the first tube lens 102e and second tube lens 104b have a linearly adjustable position to provide for M_{RR} to be continuously tuned to approximately equal to a ratio of (nₛ/n₂). Other configurations for the optical compensator are within the spirit of this disclosure, e.g., a zoom image relay system where the optical compensator is disposed between the tube lenses of the first and second microscopes, and the specific design of the optical compensator is in no way limited to the specific embodiments disclosed herein. The at least linearly adjustable lens of the optical compensator is an advance over existing remote refocus microscopy systems, which have generally used static or fixed optical configurations to set the M_{RR} for a particular nₛ with the expectation that nₛ typically does not substantially deviate from that of the first objective lens n₁. The use of at least one lens having a linearly adjustable position enables the adjustment of the refractive index of the optical compensator 106 to a biologically relevant range, e.g., a refractive index range of about 1.33-1.51, such that systems disclosed herein are suitable for the imaging of a large range of live biological samples.

With continued reference to FIGS. 1A-1C, the system 100a, 100b, and 100c includes additional components to provide for a display to an end user or operator of the image of the sample 101. As illustrated, system 100a, 100b, and 100c can include an optional third microscope 108 having appropriate optics to direct substantially all of the light from the second microscope 104 to a camera 109. The camera 109 may be any suitable camera used for microscopy and can be connected to any suitable display 110 to show a representation of the imaged sample 101. This disclosure is in no way limited by the choices for the optional third microscope 108, camera 109, and display 110.

As disclosed herein, the systems illustrated in FIGS. 1A-1C provide for the choosing of the refractive index of the first objective lens 102a, 102b, and 102c that permit different modes of operation for a fixed sample refractive index nₛ where the remote region, i.e., the second microscope 104 and optical compensator 106 can be optimized for nₛ. A first mode of operation is illustrated in FIG. 1A where the sample refractive index nₛ is equal, i.e., matched, to the first refractive index n₁, e.g., sample 101 is an aqueous sample and first objective lens 102a is a water immersion objective. In this configuration, matching n₁ and nₛ provides for a microscopy system that increases the maximum range of the full system, both the standard focusing objective, i.e., the first microscope 102 with first objective 102a, and the remote focusing objectives, i.e., the second microscope 104 with second objective 104 and the optical compensator 106. A second mode of operation is illustrated in FIG. 1B where the sample refractive index nₛ is greater than the first refractive index n₁, e.g., a mismatched RI experiment where sample 101 is an aqueous sample and first objective 102b is an air objective, i.e., no immersion. In this configuration, the first objective 102b has a limited focusing range in aqueous samples with the remote focusing objectives, i.e., the second microscope 104 with second objective 104 and the optical compensator 106, arranged for imaging any sample capable of being imaged by the optical compensator, i.e., having a refractive index between 1.33-1.51. This configuration expands the range of typical immersion-free microscopy for uses where not using an immersion objective is beneficial. A third mode of operation is illustrated in FIG. 1C where the sample refractive index nₛ is less than the first refractive index n₁, e.g., a mismatched RI experiment where sample 101 is an aqueous sample and first objective 102c is an oil immersion objective. In this configuration, the first objective 102c provides for a limited focusing range in aqueous samples with the remote focusing objectives, i.e., the second microscope 104 with second objective 104 and the optical compensator 106, arranged for imaging any sample capable of being imaged by the optical compensator, i.e., having a refractive index between 1.33-1.51. This configuration, due to the large NA value of the oil immersion first objective, increases the light collection of the microscopy system for improving imaging of samples that benefit from increased light collection, such as live biological samples.

In some embodiments, the nₛ is in a range of 1.00 to 2.00, e.g., from 1.00 to about 1.40, about 1.25 to about 1.60, about 1.50 to about 1.80, or about 1.75 to about 2.00, e.g., about 1.00, about 1.01, about 1.02, about 1.03, about 1.04, about 1.05, about 1.06, about 1.07, about 1.08, about 1.09, about 1.10, about 1.11, about 1.12, about 1.13, about 1.14, about 1.15, about 1.16, about 1.17, about 1.18, about 1.19, about 1.20, about 1.21, about 1.22, about 1.23, about 1.24, about 1.25, about 1.26, about 1.27, about 1.28, about 1.29, about 1.30, about 1.31, about 1.32, about 1.33, about 1.34, about 1.35, about 1.36, about 1.37, about 1.38, about 1.39, about 1.40, about 1.41, about 1.42, about 1.43, about 1.44, about 1.45, about 1.46, about 1.47, about 1.48, about 1.49, about 1.50, about 1.51, about 1.52, about 1.53, about 1.54, about 1.55, about 1.56, about 1.57, about 1.58, about 1.59, about 1.60, about 1.61, about 1.62, about 1.63, about 1.64, about 1.65, about 1.66, about 1.67, about 1.68, about 1.69, about 1.70, about 1.71, about 1.72, about 1.73, about 1.74, about 1.75, about 1.76, about 1.77, about 1.78, about 1.79, about 1.80, about 1.81, about 1.82, about 1.83, about 1.84, about 1.85, about 1.86, about 1.87, about 1.88, about 1.89, about 1.90, about 1.91, about 1.92, about 1.93, about 1.94, about 1.95, about 1.96, about 1.97, about 1.98, about 1.99, or about 2.00. In particular embodiments, nₛ is in a range of 1.33 to 1.51, e.g., a range for live biological samples.

In some embodiments, the n₁ is in a range of 1.00 to 2.00, e.g., from 1.00 to about 1.40, about 1.25 to about 1.60, about 1.50 to about 1.80, or about 1.75 to about 2.00, e.g., about 1.00, about 1.01, about 1.02, about 1.03, about 1.04, about 1.05, about 1.06, about 1.07, about 1.08, about 1.09, about 1.10, about 1.11, about 1.12, about 1.13, about 1.14, about 1.15, about 1.16, about 1.17, about 1.18, about 1.19, about 1.20, about 1.21, about 1.22, about 1.23, about 1.24, about 1.25, about 1.26, about 1.27, about 1.28, about 1.29, about 1.30, about 1.31, about 1.32, about 1.33, about 1.34, about 1.35, about 1.36, about 1.37, about 1.38, about 1.39, about 1.40, about 1.41, about 1.42, about 1.43, about 1.44, about 1.45, about 1.46, about 1.47, about 1.48, about 1.49, about 1.50, about 1.51, about 1.52, about 1.53, about 1.54, about 1.55, about 1.56, about 1.57, about 1.58, about 1.59, about 1.60, about 1.61, about 1.62, about 1.63, about 1.64, about 1.65, about 1.66, about 1.67, about 1.68, about 1.69, about 1.70, about 1.71, about 1.72, about 1.73, about 1.74, about 1.75, about 1.76, about 1.77, about 1.78, about 1.79, about 1.80, about 1.81, about 1.82, about 1.83, about 1.84, about 1.85, about 1.86, about 1.87, about 1.88, about 1.89, about 1.90, about 1.91, about 1.92, about 1.93, about 1.94, about 1.95, about 1.96, about 1.97, about 1.98, about 1.99, or about 2.00. In particular embodiments, n₁ is in a range of 1.00 to 1.51. For example, the range for n₁ of 1.00 to 1.51 applies to first objectives for air, water immersion, and oil immersion objectives. Other objectives for the first objectives are contemplated by this disclosure, and this disclosure is in no way limited by the choice of objective for the first objective and its associated refractive index.

In accordance with an aspect, there is provided a method of configuring a remote refocus system including a first microscope and a second microscope for imaging a sample. The method may include selecting a first objective for the first microscope based on a chosen compromise between first, second, and third modes of operation for the remote refocus system and a refractive index of the sample. The first, second, and third modes of operation may include: 1) the first mode of operation being the use of immersion-free objective for the first microscope where the sample refractive index nₛ is greater than a first refractive index n₁ of the first objective; 2) the second mode of operation being expanded focus range of the first objective where the sample refractive index nₛ is substantially identical to the first refractive index n₁ of the first objective; and 3) the third mode of operation maximizing the numerical aperture of the first objective where the sample refractive index nₛ is less than the first refractive index n₁ of the first objective. The method may include selecting a second objective having second refractive index n₂ for the second microscope, with the first microscope and second microscope being configured to produce an intermediate image of the sample with a magnification M_{RR}. The method further may include selecting a combination of optics for an optical compensator disposed between the first and second objective to collect substantially all the emission light from the first objective. The optical compensator may have a linearly adjustable position to provide for M_{RR} to be continuously tuned to approximately equal to a ratio of (nₛ/n₂).

In some embodiments, selecting the first objective may include selecting an air objective. In some embodiments, selecting the first objective may include selecting a water immersion objective. In some embodiments, selecting the first objective may include selecting an oil immersion objective. For example, an oil immersion objective may include a silicone oil immersion objective or a glycerol immersion objective.

### EXAMPLES

The function and advantages of these and other embodiments can be better understood from the following examples. These examples are intended to be illustrative in nature and are not considered to be in any way limiting the scope of the invention.

### Example 1—Standard Widefield Imaging

In this example, optical components compatible with a single-objective light-sheet (SOLS) microscope design were used to evaluate several configurations, which permitted control of the numerical aperture, focal length and immersion medium for a given setup. The objectives used in the test setup included a 40×0.95 air objective, a 60×1.27 water immersion objective, a 100×1.35 silicone oil objective, and a 100×1.45 oil objective. Using these setups, the standard focus and remote refocus ranges were calculated as a function of the sample refractive index nₛ over the biological range of 1.33≤nₛ≤1.51.

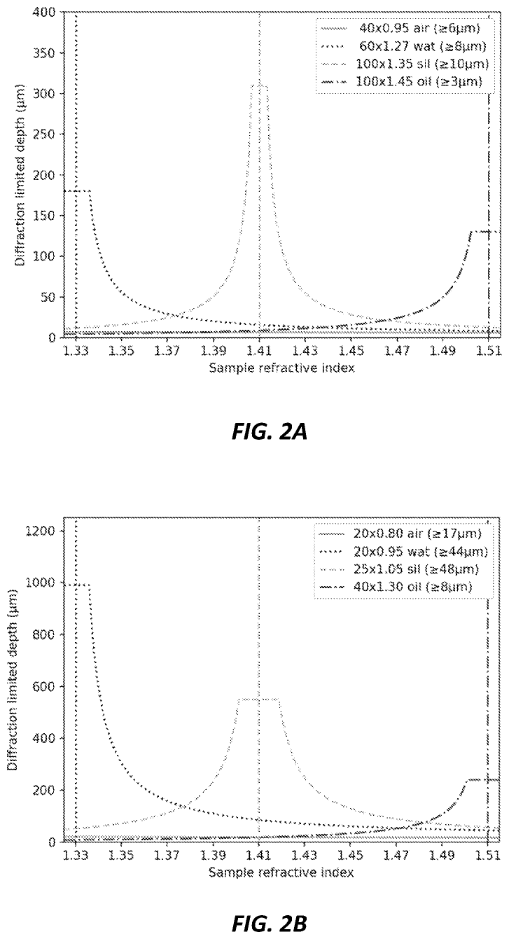

FIGS. 2A-2B illustrate the accessible imaging range of different objectives in a typical widefield microscope, with FIG. 2A showing the range for objectives having the greatest NA and FIG. 2B showing the range for objectives having the greatest number of pixels, i.e., Nyquist pixels. In FIGS. 2A-2B, the diffraction limited depth of standard focus was plotted as a function of the sample RI, calculated as:

$${z}_{{sf}_{max}} = \frac{λ}{2 {sin}^{4} ( {θ}_{1} / 2 )} \vert \frac{{n}_{s}^{3}}{{n}_{1}^{2} ( {n}_{s}^{2} - {n}_{1}^{2} )} \vert$$

where z_{sf_max} is the maximum depth of standard focus, λ is the wavelength, θ₁ is the half angle of the first objective, and n₁ and nₛ are as defined above. As illustrated in FIG. 2A, for first objectives having a high NA, the 100×1.35 silicone oil objective offered the best compromise for varying sample types, with a minimum range of 10 μm for any sample RI. Similar trends were observed for objectives having the most pixels as illustrated in FIG. 2B. However, for aqueous samples, the 60×1.27 water lens had a substantially larger range that was limited only by the working distance at 180 μm. The 40×0.95 air objective had the lowest performance for imaging depth, offering only about 6 μm of imaging depth for any liquid sample. The 100×1.45 oil immersion objective had the lowest performance for live biological samples with the inconvenience of liquid immersion and the lowest range in “watery” samples, i.e., forcing the 3 μm lower bound. In the standard widefield microscope test setup, for any sample RI under approximately 1.36, FIG. 2B illustrates that the 60×1.27 water objective had the highest diffraction limited depth. In this regime, the other simulated objectives, i.e., air, silicone and oil, had less utility and were generally best suited for the imaging of shallow 3D samples, e.g., depth of less than 10 μm, or specific imaging experiments where the lack of immersion or marginal increase in NA will be required, e.g., high-speed 2D tiling or total internal reflection fluorescence (TIRF) microscopy. The 60×1.27 water objective had a 333 μm field of view (FOV), a theoretical resolving power of about 250 nm and a 2600 pixel count, and thus the water objective would pair well with current scientific Complementary Metal-Oxide-Semiconductor (sCMOS) imaging cameras. Although the water objective was sensitive to coverslip tilt and coverslip thickness and further required regular hydration, the 60×1.27 water objective offered the strongest 3D imaging performance in for the high NA objectives.

### Example 2—Remote Refocus Imaging

To evaluate the deeper imaging potential of a remote refocus microscope as disclosed herein, this example models a series of commercially available objectives used in the remote refocus setup disclosed herein compared to a standard widefield microscope, i.e., a microscope with no remote optics, as described in Example 1 and illustrated in FIGS. 2A-2B.

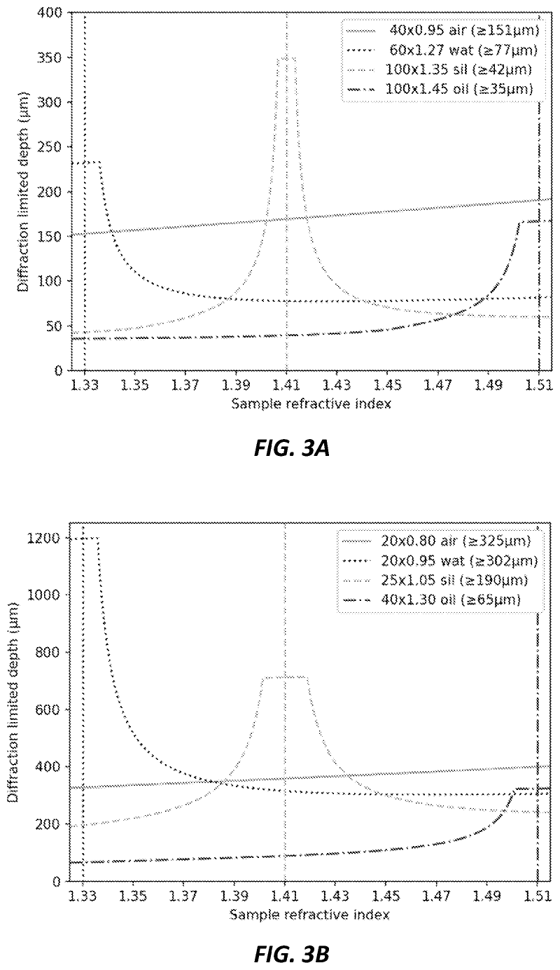

FIGS. 3A-3B illustrate the accessible imaging range of different objectives in a combined microscopy system including a standard focus, i.e., a first microscope as described herein, and a remote refocus microscope, i.e., a second microscope and optical compensator as described herein, e.g., as illustrated in FIGS. 1A-1C. FIG. 3A shows the range for objectives having the greatest NA and FIG. 3B shows the range for objectives having the greatest number of pixels, i.e., Nyquist pixels. In the combined standard focus, i.e., first microscope as described herein, and remote refocus microscope, i.e., second microscope and optical compensator as described herein, the first objectives used in the test setup included a 40×0.95 air objective, a 60×1.27 water immersion objective, a 100×1.35 silicone oil objective, and a 100×1.45 oil objective. The inclusion of the second microscope and the optical compensator with an adjustable tube lens permitted optimization, i.e., tuning, of the remote refocus optics, i.e., the tube lenses of one or both of the first or second microscope, continuously across the range of the sample RI nₛ. As illustrated in FIGS. 3A-3B, each of the tested configurations benefited from the additional imaging range provided by the optical compensator, with the maximum focus range in the sample calculated as the sum of the standard and remote ranges, i.e., zₘₐₓ≈z_{sf}_{ₘₐₓ}+|zᵣᵣ_{ₘₐₓ}|, with z_{rr_max} defined as:

$${z}_{rr \_ max} = ∓ \frac{1}{2 {sin}^{2} ( {θ}_{s} / 2 )} \sqrt[4]{\frac{15 {λ}^{2} {f}^{2} ( 3 + 8 cos {θ}_{s} + cos 2 {θ}_{s} )}{{π}^{2} {n}_{s}^{2} ( 3 + 16 cos {θ}_{s} + cos 2 {θ}_{s} )}}$$

where λ is the wavelength, f is the focal length of the first objective, and θₛ is the collection half angle in the in the sample which is related via Snell's law to the collection half angle and refractive index of the first objective. As illustrated in FIG. 3A, for the high NA objectives, the lower bound on the 100×1.45 oil lens increased from 3 μm to 35 μm, increasing the utility of this setup for a number of biologically relevant applications. In practice, this setup delivered deeper imaging at maximum NA for any sample RI under 1.45. As further illustrated in FIG. 3A, the largest improvement for high NA objectives was the substantial increase in imaging depth available to the 40×0.95 air objective, which as illustrated in FIG. 3 provided immersion-free imaging up to 151 μm of diffraction limited depth. In this configuration, the remote optics, i.e., the second microscope and optical compensator, can be optimized for any sample capable of being imaged by the optical compensator, i.e., having a refractive index between 1.33-1.51 with multiple objectives, such as a 40×1.15 water objective for maximum depth having a 600 μm working distance, a 40×0.95 air objective to take advantage of the speed and convenience of for immersion-free imaging, or a 40×1.30 oil objective for maximum NA imaging. These objectives can be chosen to have the same focal length, and thus they would be interchangeable on the same microscopy system. Under these conditions, and at 40× magnification, these objectives offer larger fields of view, e.g., 500 μm, and greater pixel counts, e.g., in excess of 2927 pixels, than the 60×1.27 water objective as described in Example 1. In addition, it is noted that a sample-optimized remote refocus microscopy system can avoid the axial “stretching.” i.e., n₁>nₛ and “squashing.” i.e., n₁<nₛ, distortions from using standard focus with mismatched immersion objectives.

### Example 3—Zoom Lens System

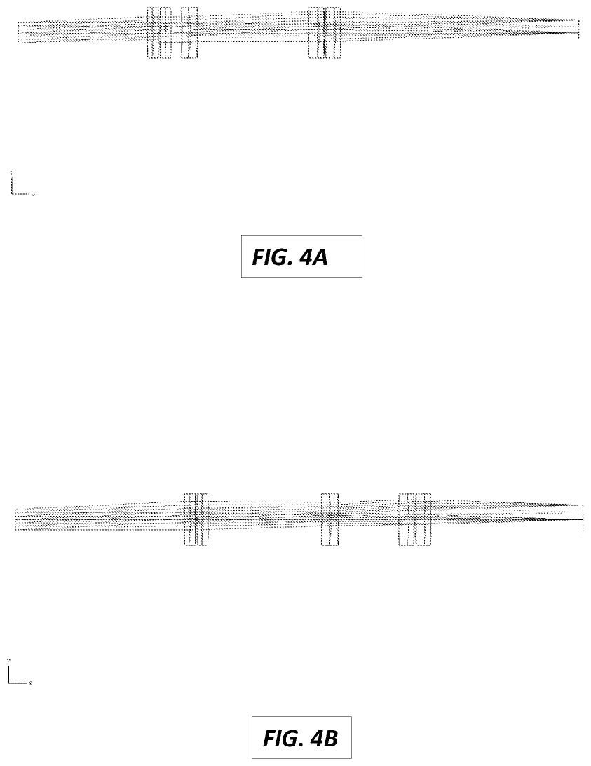

FIGS. 4A-4B illustrate a constant track length zoom lens design for incorporation into the second tube lens of a remote refocus microscope as disclosed herein. With reference to the microscope configuration illustrated in FIGS. 1A-1C, the second tube lens 104b location was chosen as a convenient installation point for the zoom lens as it left the first objective 102a, 102b, 102c and the first tube lens 102e in their traditional, i.e., stock, configuration. The constant track length, i.e., doubly telecentric, design of the zoom lens maintained the axial position of both the front and back focal planes of the zoom lens such that the focal length could be adjusted over the full range, i.e., 132.5-150 mm without disrupting the optical train of the microscope. In this example, the zoom lens was chromatically corrected over the visible spectrum, i.e., 450-700 nm, and was designed to be paired with a second microscope objective, i.e., objective 104a in FIGS. 1A-1C, having a back focal plane diameter up to 9.5 mm diameter, e.g., a Nikon 40×0.95 air objective suitable for diffraction limited performance over a 13.5 mm diameter field of view typical of a sCMOS imaging camera. The zoom lens having focal length 132.5-150 mm and second objective with a focal length of 5 mm was able to continuously adjust the second microscope magnification in the range 26.5-30×. Using a first microscope with a 40× magnification in combination with the second microscope described above produced a remote refocus magnification (M_{RR}) that was continuously adjustable in the range 1.33 and 1.51. FIG. 4A illustrates a mag. 1.51 (f=132.5 mm) constant track length zoom lens configuration and FIG. 4B illustrates a mag. 1.33 (f=150 mm) constant track length zoom lens configuration.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, it is to be appreciated that embodiments of the methods and apparatuses discussed herein are not limited in application to the details of construction and the arrangement of components set forth in the foregoing description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including.” “comprising.” “having.” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation. Accordingly, the foregoing description and drawings are by way of example only, and the scope of the invention should be determined from proper construction of the appended claims, and their equivalents.

What is claimed is:

1. A remote refocus system configured to image a sample, the system comprising:
a first microscope arranged to receive light from the sample in a medium having a sample refractive index nₛ, the first microscope including a first objective lens having a first numerical aperture NA₁ and a first immersion medium with a first refractive index n₁;
a second microscope including a second objective lens having a second numerical aperture NA₂ and a second refractive index n₂, the second objective lens arranged to receive light passing through the first microscope, the combination of the first microscope and second microscope being configured to produce an intermediate image of the sample with a magnification M_{RR}; and
an optical compensator disposed between the first microscope and the second microscope, the optical compensator comprising at least one lens having a linearly adjustable position to provide for M_{RR} to be continuously tuned to approximately equal to a ratio of (nₛ/n₂).

2. The system of claim 1, wherein the sample refractive index nₛ is greater than the first refractive index n₁.

3. The system of claim 1, wherein the sample refractive index nₛ is less than the first refractive index n₁.

4. The system of claim 1, wherein the sample refractive index nₛ is substantially the same as the first refractive index n₁.

5. The system of claim 1, wherein M_{RR} is approximately equal to a ratio of (nₛ/n₂) of the refractive indices of the sample and second microscope.

6. The system of claim 1, wherein nₛ is in a range of 1.00 to 2.00.

7. The system of claim 6, wherein nₛ is in a range of 1.33 to 1.51.

8. The system of claim 1, wherein n₁ is in a range of 1.00 to 2.00.

9. The system of claim 8, wherein n₁ is in a range of 1.00 to 1.51.

10. The system of claim 1, wherein the first objective is constructed and arranged to be switched between different objectives having the same focal length but different refractive indices n₁ such that the system maintains M_{RR} approximately equal to a ratio of (nₛ/n₂).

11. The system of claim 1, wherein the first objective is constructed and arranged to be switched between different objectives having different focal lengths and different refractive indices n₁ such that the optical compensator maintains M_{RR} approximately equal to a ratio of (nₛ/n₂).

12. The system of claim 1, wherein a collection half angle of the second objective is greater than or approximately equal to a collection half angle of the first objective.

13. A modular microscopy system for imaging a sample, the system comprising:
a sample stage constructed and arranged for holding sample immersed in a sample medium having sample refractive index nₛ;
a first microscope having a first objective lens having a first numerical aperture NA₁ and a first immersion medium with a first refractive index n₁;
a second microscope having a second objective lens having a second numerical aperture NA₂ and a second refractive index n₂, the combination of the first microscope and second microscope configured to produce an intermediate image of the sample with a magnification M_{RR}; and
an optical compensator disposed between the first microscope and the second microscope and comprising at least one lens having a linearly adjustable position to provide for M_{RR} to be continuously tuned to approximately equal to a ratio of (nₛ/n₂),
the modular microscopy system having the sample refractive index nₛ and the first refractive index n₁ chosen to permit operation in three modes:
a first mode where the sample refractive index nₛ is equal to the first refractive index n₁;
a second mode where the sample refractive index nₛ is greater than the first refractive index n₁; and
a third mode where the sample refractive index nₛ is less than the first refractive index n₁.

14. The system of claim 13, wherein nₛ is in a range of 1.00 to 2.00.

15. The system of claim 14, wherein nₛ is in a range of 1.33 to 1.51.

16. The system of claim 13, wherein n₁ is in a range of 1.00 to 2.00.

17. The system of claim 16, wherein n₁ is in a range of 1.00 to 1.51.

18. A method of configuring a remote refocus system for imaging a sample, the system including a first microscope, a second microscope, the method comprising:
selecting a first objective for the first microscope based on a chosen compromise between first, second, and third modes of operation for the remote refocus system and a refractive index of the sample nₛ, the first, second, and third modes of operation including:
the first mode of operation being the use of immersion-free objective for the first microscope where the sample refractive index nₛ is greater than a first refractive index n₁ of the first objective,
the second mode of operation being expanded focus range of the first objective where the sample refractive index nₛ is substantially identical to the first refractive index n₁ of the first objective, and
the third mode of operation maximizing the numerical aperture (NA) of the first objective where the sample refractive index nₛ is less than the first refractive index n₁ of the first objective;
selecting a second objective having a second refractive index n₂ for the second microscope, the first microscope and second microscope being configured to produce an intermediate image of the sample with a magnification M_{RR}; and
selecting a combination of optics for an optical compensator disposed between the first and second objective to collect substantially all the emission light from the first objective, the optical compensator having a linearly adjustable position to provide for M_{RR} to be continuously tuned to approximately equal to a ratio of (nₛ/n₂).

19. The method of claim 18, wherein selecting the first objective includes selecting an air objective.

20. The method of claim 18, wherein selecting the first objective includes selecting a water immersion objective.

21. The method of claim 18, wherein selecting the first objective includes selecting a silicone oil immersion objective.

22. The method of claim 18, wherein selecting the first objective includes selecting a glycerol immersion objective.

23. The method of claim 18, wherein selecting the first objective includes selecting an oil immersion objective.
